(19) United States
(12) Patent Application Publication
(10) Pub. No.: US 2007/0053515 A1
(43) Pub. Date: Mar. 8, 2007

(54) Semiconductor device using a read-only memory (ROM) scrambling/descrambling method, and a method of operating the same

(75) Inventors: Eui-Seung Kim, Suwon-si (KR); Jong-Cheol Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/499,153

(22) Filed: Aug. 4, 2006

(30) Foreign Application Priority Data
Aug. 18, 2005 (KR) 10-2005-0075538

(51) Int. Cl. H04N 7/167

(52) U.S. Cl. 380/239

(57) ABSTRACT

A semiconductor device includes a processor, a read-only memory (ROM), a key generator, and a restoration unit. The ROM stores scrambled or encrypted run code and key generation information. The key generator generates a key using the key generation information. The restoration unit restores original run code by descrambling the scrambled run code or decrypting the encrypted run code using the generated key.

### CROSS-REFERENCE TO RELATED PATENT APPLICATION

This application claims priority to Korean Patent Application No. 10-2005-0075538, filed on Aug. 18, 2005, in the Korean Intellectual Property Office, the disclosure of which is incorporated by reference herein in its entirety.

### BACKGROUND OF THE INVENTION

1. Technical Field

The present disclosure relates to a semiconductor device using a read-only memory (ROM) scrambling/descrambling method and a method of operating the same.

2. Discussion of the Related Art

In general, when a semiconductor device is powered on, a processor, e.g., a central processing unit (CPU), reads run code at a specific address in a memory to perform a user desired routine. Run code is generally stored in a read-only memory (ROM).

For security purposes, a ROM scrambling method has been used to prevent the run code from being hacked. The scrambling method scrambles the run code by using a predetermined scramble key and stores the scrambled run code in a ROM. The scrambled run code is then descrambled by using a descramble key before it can be executed. In general, a descramble key is the same as a scramble key.

However, in the ROM scrambling method, a key for descrambling run code is generally fixed. For example, scrambled run code is descrambled using a hard-wired key. Thus, in a semiconductor device such as a smart card chip, if different customers use the same type of device or a version of its run code is updated, the run code is scrambled/descrambled using the same key.

Since the run code can be read from the ROM by hacking a fixed key, a security level of the run code is low. Accordingly, there is a need for a scrambling technique that is capable of increasing a security level of the run code in a ROM.

### SUMMARY OF THE INVENTION

According to an exemplary embodiment of the present invention, there is provided a semiconductor device which includes a processor, a read-only memory (ROM), a key generator, and a restoration unit. The ROM stores scrambled or encrypted run code and key generation information. The key generator generates a key using the key generation information. The restoration unit restores original run code by descrambling the scrambled run code or decrypting the encrypted run code using the generated key.

The key generation information may include at least one of information regarding the semiconductor device and information regarding a version of the original run code. The restoration unit may include at least one of a descrambler and a decryptor.

The semiconductor device may include an initial controller that controls the key generation information output from a test region of the ROM when power or a reset signal is supplied to the semiconductor device.

The initial controller comprises an address of the test region which stores the key generation information.

The key generator generates a key generation completion signal when the key is generated, and the processor executes the restored original run code in response to a delayed version of the key generation completion signal.

The semiconductor device may include a flip flop that receives the key generation completion signal, delays the key generation completion signal and outputs the delayed version of the key generation completion signal to the processor.

According to an exemplary embodiment of the present invention, there is provided a semiconductor device which includes a processor, a ROM and a restoration unit. The ROM stores a key, and scrambled or encrypted run code. The restoration unit reads the key from the ROM and restores original run code by descrambling the scrambled run code or decrypting the encrypted run code using the key, before execution of the run code.

The semiconductor device may include an initial controller which controls the key output from the ROM when power or a reset signal is supplied to the semiconductor device.

The ROM may include a user region and a test region, wherein the scrambled or encrypted run code is stored in the user region and the key is stored in the test region.

The initial controller may include an address of the test region storing the key. The key may be stored in the ROM during a manufacturing process of the semiconductor device.

According to an exemplary embodiment of the present invention, there is provided a method of operating a semiconductor device having a ROM, a processor, a key generator and a restoration unit. The ROM stores key generation information and scrambled or encrypted run code. The method includes reading the key generation information from the ROM when power or a reset signal is supplied to the semiconductor device, generating, at the key generator, a key using the key generation information, restoring, at the restoration unit, original run code by descrambling the scrambled run code or decrypting the encrypted run code using the key, and executing, at the processor, the restored original run code.

The method may further include generating, at the key generator, a key generation completion signal when the key is generated. The original run code may be restored after the key generation completion signal is generated.

The key generation information and the scrambled or encrypted run code may be stored in the ROM during a manufacturing process of the semiconductor device. Different key generation information may be set for each version of the original run code.

According to an exemplary embodiment of the present invention, there is provided a method of operating a semiconductor device having a ROM, a processor and a restoration unit. The ROM stores a key and scrambled or encrypted run code. The method includes extracting the key and scrambled or encrypted run code from the ROM when power or a reset signal is supplied to the semiconductor device, restoring, at the restoration unit, original run code by descrambling the scrambled run code or decrypting the encrypted run code using the extracted key, and executing, at the processor, the restored original run code.

The key and the scrambled or encrypted run code may be stored in the ROM during a manufacturing process of the semiconductor device. A different key may be set for each version of the original run code.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a read-only memory (ROM) scrambling/descrambling method according to an exemplary embodiment of the present invention;

FIG. 2 is a block diagram of a semiconductor device according to an exemplary embodiment of the present invention;

FIG. 3 is a block diagram illustrating an initial controller and ROM of FIG. 2 according to an exemplary embodiment of the present invention;

FIG. 4 is a flowchart illustrating a method of operating a semiconductor device according to an exemplary embodiment of the present invention; and

FIG. 5 a flowchart illustrating a method of operating a semiconductor device according to an exemplary embodiment of the present invention.

### DETAILED DESCRIPTION OF EXEMPLARY EMBODIMENTS

The present invention will now be described in detail with reference to the accompanying drawings, in which exemplary embodiments of the invention are shown. Like reference numerals denote like elements throughout the drawings.

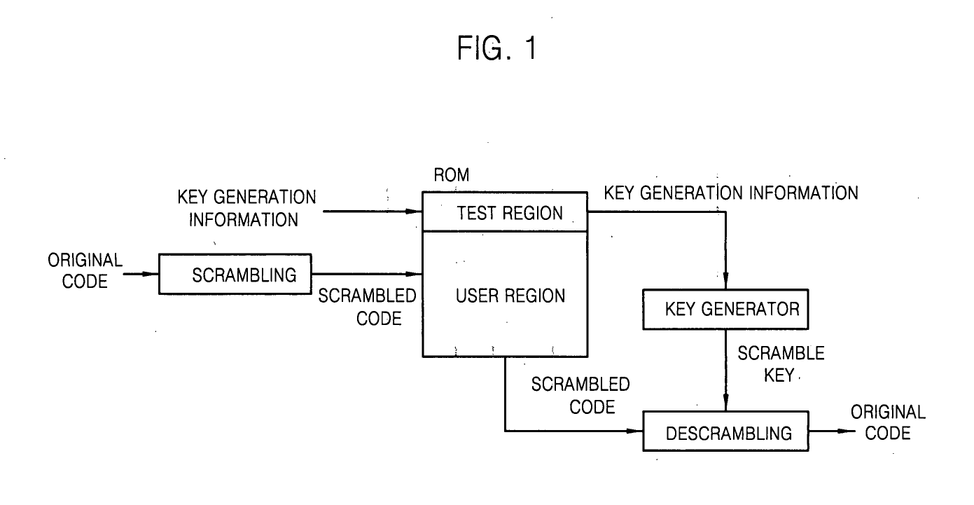

FIG. 1 is a diagram illustrating a read-only memory (ROM) scrambling/descrambling method according to an exemplary embodiment of the present invention. Referring to FIG. 1, key generation information is stored in a predetermined region of a ROM. The key generation information is used to generate a descramble key, and may include information regarding a semiconductor device (not shown) and information regarding a version of run code. Further, scrambled code is also stored in the predetermined region of the ROM. The scrambled code is run code obtained by scrambling original run code by using a scramble key. Here, the scramble key is the same as the descramble key.

The predetermined region of the ROM is divided into a user region and a test region. The scrambled code may be stored in the user region, and the key generation information may be stored in the test region. The test region is a region of the ROM, in which run code is not stored. A manufacturer of the semiconductor device uses the test region for testing the semiconductor device.

If the key generation information and the scrambled code are stored in the ROM, the semiconductor device descrambles the scrambled code prior to execution of the run code. To descramble the scrambled code, when power or a reset signal is supplied to the semiconductor device from an external device, the semiconductor device first reads the key generation information from the predetermined region of the ROM. A key generator generates a key from the read key generation information. If the key is generated, the scrambled code read from the ROM is descrambled using the generated key to restore the original run code.

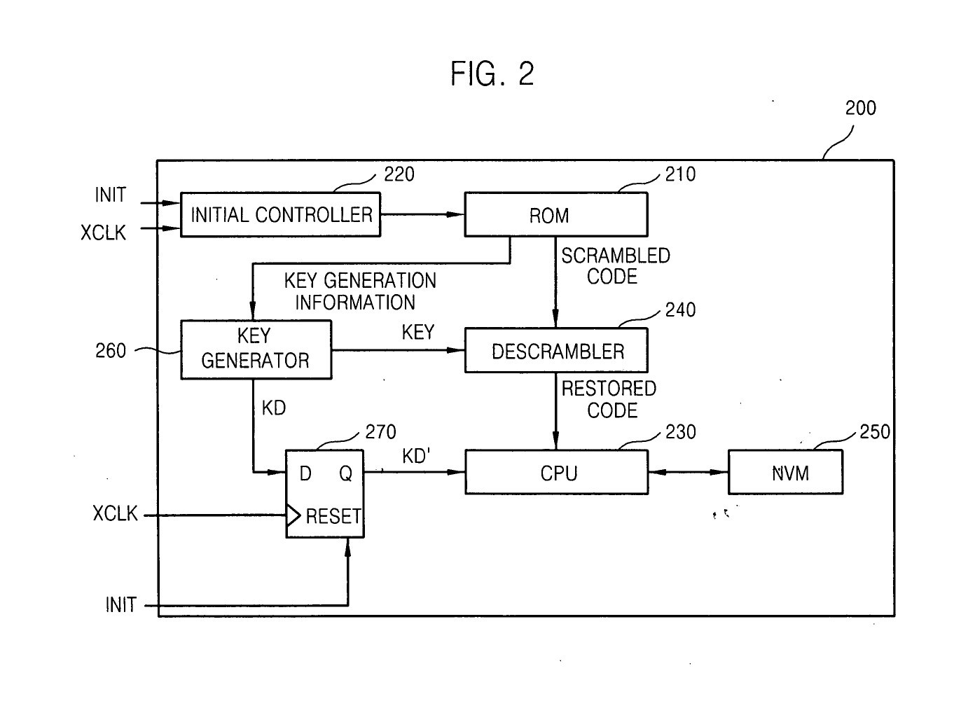

FIG. 2 is a block diagram of a semiconductor device 200 according to an exemplary embodiment of the present invention. Referring to FIG. 2, the semiconductor device 200 includes a ROM 210, an initial controller 220, a processor 230, a descrambler 240, a nonvolatile memory (NVM) 250, and a key generator 260. In the semiconductor device 200, the ROM 210 stores run code for performing a predetermined routine such as a user desired routine. The semiconductor device 200 may be a smart card or an integrated circuit card device.

The ROM 210 is a memory for storing scrambled code and key generation information. The ROM 210 may be a mask ROM or a programmable ROM (PROM). The key generation information may be stored in the ROM 210 during a manufacturing process of the semiconductor device 200. For example, the key generation information and the scrambled run code may be stored in the ROM 210 during a ROM code mask process performed when manufacturing the semiconductor device 200. It is preferable that the key generation information varies according to the run code and includes information regarding a version of the run code. The key generation information is stored in a test region of the ROM 210.

The initial controller 220 controls the key generation information to be supplied to the key generator 260 from the ROM 210, in response to a clock signal XCLK and an initial signal INIT. The initial signal INIT may be an internal signal activated when the semiconductor device 200 is powered on or in response to a reset signal. Thus, the initial controller 220 controls the key generation information to be output from a predetermined region of the ROM 210 when power is supplied to the semiconductor device 200 or when the semiconductor device 200 is reset.

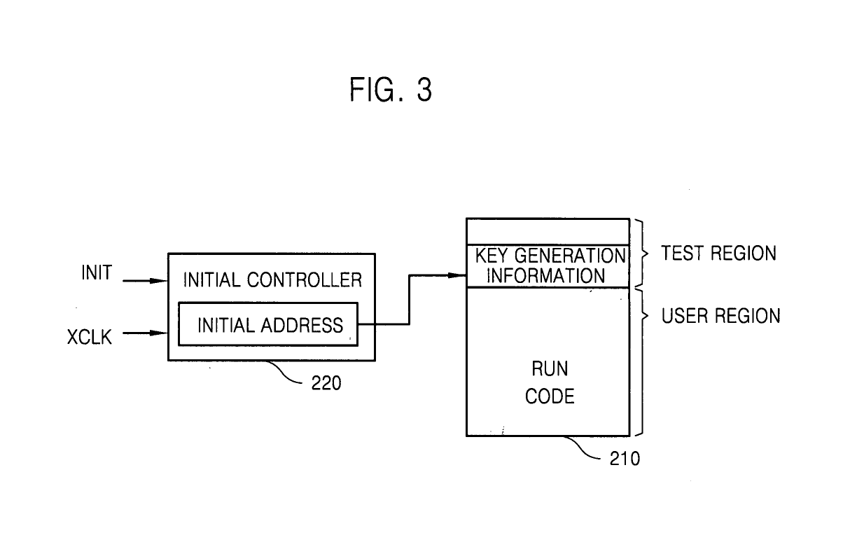

As illustrated in FIG. 3, the initial controller 220 includes an address (e.g., initial address) indicating the predetermined region in which the key generation information is stored, and controls data (e.g., the key generation information) to be output from the predetermined region indicated by the initial address, in response to the initial signal INIT.

The key generator 260 generates a key (e.g., a descramble key) from the key generation information output from the ROM 210. After generating the key, the key generator 260 may generate a key generation completion signal KD. The key generation completion signal KD is preferably input to the processor 230 via a flip flop 270, not directly from the key generator 260. The flip flop 270 respectively receives the key generation completion signal KD and the clock signal XCLK via an input terminal (e.g., D terminal) and a clock terminal thereof, and is reset by the initial signal INIT.

The descrambler 240 restores the run code by descrambling code read from the ROM 210 by using the generated key. The descrambler 240 may be a logic gate, e.g., an exclusive-OR (XOR) gate, which performs an XOR operation on the key and the code read from the ROM 210.

The processor 230 performs the predetermined routine by executing the descrambled code in response to the key generation completion signal KD or KD′.

The NVM 250, which is included in the semiconductor device 200 to store data, may be a flash memory. According to an exemplary embodiment of the present invention, the key generation information is stored together with the run code in the ROM 210, not in the NVM 250.

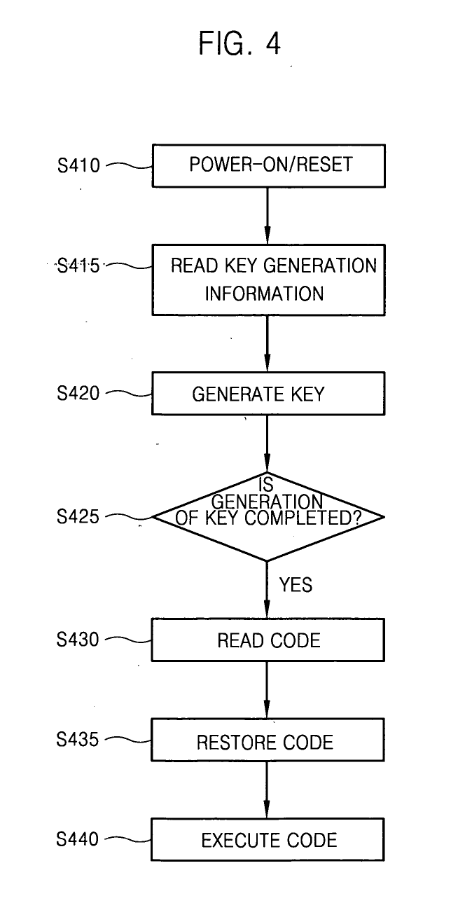

FIG. 4 is a flowchart illustrating a method of operating a semiconductor device according to an exemplary embodiment of the present invention. This method is performed by the semiconductor device 200 illustrated in FIG. 2 and will be described with reference thereto.

When the semiconductor device 200 is powered on or reset (S410), key generation information is first read from a ROM 210 of the semiconductor device 200 (S415). Prior to reading the key generation information, run code is scrambled or encrypted and stored in the ROM 210, and the key generation information used to generate a key for scrambling/encrypting the run code is also stored in the ROM 210. The key for scrambling/encrypting the run code may be the same as a key for descrambling/decrypting the run code.

Next, the key is generated from the key generation information read from the ROM 210 (S420). When it is determined that the key is generated (S425), the run code is read from the ROM 210 (S430). The run code read from the ROM 210 may be a run code which was processed, for example, by a scrambling or encryption method.

The run code is restored by using the generated key (S435). In other words, the original run code is restored by descrambling/decrypting the run code read from the ROM 210 using the generated key.

The run code may be read before the key is generated. However, the run code is descrambled/decrypted after the key has been generated. Next, when the original run code is restored by descrambling/decrypting the run code, a processor 230 executes the restored code (S440).

According to the above-described exemplary embodiments of the present invention, the key generation information is stored in the ROM 210, the key is generated using the key generation information, and the original run code is restored by using the generated key. However, a key may be stored in the ROM 210, instead of the key generation information.

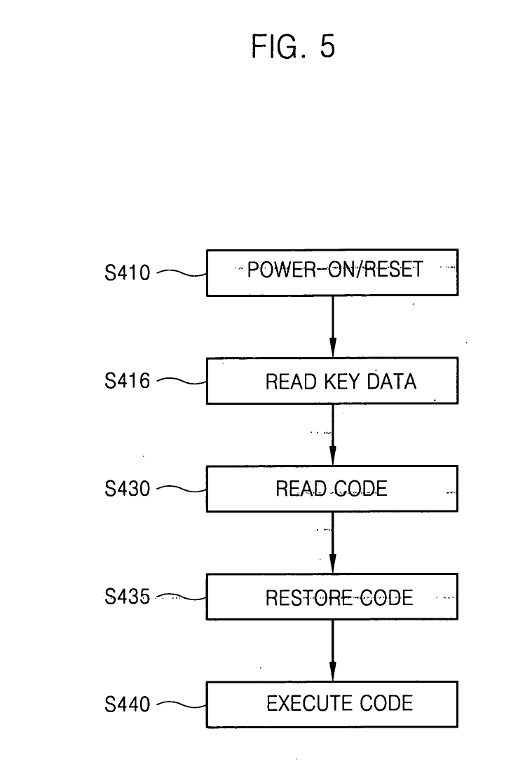

FIG. 5 is a flowchart illustrating a method of operating a semiconductor device according to an exemplary embodiment of the present invention. In particular, FIG. 5 illustrates a case where a key is stored directly in a ROM.

Referring to FIG. 5, when a semiconductor device is powered on or reset (S410), a key is first read from a ROM of the semiconductor device (S416). Next, run code is read from the ROM (S430), the original run code is restored by descrambling the run code by using the read key (S435) and the restored code is executed (S440).

Since the key is stored directly in the ROM, a key generator is not needed. For example, a key generator 260 and a flip flop 270 of the semiconductor device 200 of FIG. 2 are not needed in this case. However, for higher security, it is preferable that the ROM stores the key generation information, not the key, and that the key is generated using the key generation information.

According to an exemplary embodiment of the present invention, the key generation information may include information regarding the semiconductor device (e.g., device information) and information regarding the version of the run code. In this case, the key generation information varies according to the semiconductor device and the version of the run code. Furthermore, when the key generation information is stored in the ROM during a ROM mask process, a different key can be generated by changing a ROM mask pattern for each customer and/or run code without modifying hardware. In addition, since a scramble/descramble key varies for each customer or run code version, a security level for the run code is increased as compared to a scrambling technique that uses the same key regardless of a customer or run code version.

The above exemplary embodiments of the present invention have been described with reference to a semiconductor device that scrambles/descrambles run code by using a key. However, the present invention is also applicable to a semiconductor device that encrypts/decrypts run code by using a key. For example, the present invention can be used in a semiconductor device that encrypts run code, stores the encrypted code in a ROM and restores the original run code by decrypting the encrypted code using the key.

According to an exemplary embodiment of the present invention, a different key can be set for each version of run code (e.g., a program) for a semiconductor device, thereby improving a security level of the run code, and thus, preventing the run code from being hacked. In addition, since key generation information for restoring the run code is stored with the run code in a ROM, the run code can be restored without having to use another memory, such as a nonvolatile memory.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. A semiconductor device comprising:
a processor;
a read-only memory storing scrambled or encrypted run code and key generation information;
a key generator generating a key using the key generation information; and
a restoration unit restoring original run code by descrambling the scrambled run code or decrypting the encrypted run code using the generated key.

2. The semiconductor device of claim 1, wherein the key generation information comprises at least one of:
information regarding the semiconductor device; and
information regarding a version of the original run code.

3. The semiconductor device of claim 1, wherein the restoration unit comprises at least one of:
a descrambler; and
a decryptor.

4. The semiconductor device of claim 1, further comprising an initial controller controlling the key generation information output from a test region of the read-only memory when power or a reset signal is supplied to the semiconductor device.

5. The semiconductor device of claim 4, wherein the initial controller comprises an address of the test region which stores the key generation information.

6. The semiconductor device of claim 1, wherein the key generator generates a key generation completion signal when the key is generated, and
the processor executes the restored original run code in response to a delayed version of the key generation completion signal.

7. The semiconductor device of claim 6, further comprising a flip flop for receiving the key generation completion signal, delaying the key generation completion signal and outputting the delayed version of the key generation completion signal to the processor.

8. A semiconductor device comprising:
a processor;
a read-only memory storing a key, and scrambled or encrypted run code;
a restoration unit reading the key from the read-only memory and restoring original run code by descrambling the scrambled run code or decrypting the encrypted run code using the key, before execution of the original run code.

9. The semiconductor device of claim 8, further comprising:
an initial controller controlling the key output from the read-only memory when power or a reset signal is supplied to the semiconductor device.

10. The semiconductor device of claim 9, wherein the read-only memory comprises a user region and a test region,
wherein the scrambled or encrypted run code is stored in the user region and the key is stored in the test region.

11. The semiconductor device of claim 10, wherein the initial controller includes an address of the test region storing the key.

12. The semiconductor device of claim 8, wherein the key is stored in the read-only memory during a manufacturing process of the semiconductor device.

13. A method of operating a semiconductor device having a read-only memory which stores key generation information and scrambled or encrypted run code, a processor, a key generator and a restoration unit, the method comprising:
reading the key generation information from the read-only memory when power or a reset signal is supplied to the semiconductor device;
generating, at the key generator, a key using the key generation information;
restoring, at the restoration unit, original run code by descrambling the scrambled run code or decrypting the encrypted run code using the key; and
executing, at the processor, the restored original run code.

14. The method of claim 13, further comprising generating, at the key generator, a key generation completion signal when the key is generated,
wherein the original run code is restored after the key generation completion signal is generated.

15. The method of claim 13, further comprising storing the key generation information and the scrambled or encrypted run code in the read-only memory during a manufacturing process of the semiconductor device.

16. The method of claim 13, further comprising setting different key generation information for each version of the original run code.

17. A method of operating a semiconductor device having a read-only memory which stores a key and scrambled or encrypted run code, a processor and a restoration unit, the method comprising:
extracting the key and scrambled or encrypted run code from the read-only memory when power or a reset signal is supplied to the semiconductor device;
restoring, at the restoration unit, original run code by descrambling the scrambled run code or decrypting the encrypted run code using the extracted key; and
executing, at the processor, the restored original run code.

18. The method of claim 17, further comprising storing the key and the scrambled or encrypted run code in the read-only memory during a manufacturing process of the semiconductor device.

19. The method of claim 17, further comprising setting a different key for each version of the original run code.
